(19) United States
(12) Patent Application Publication
(10) Pub. No.: US 2009/0012911 A1
(43) Pub. Date: Jan. 8, 2009

(54) Systems and Methods for Providing a Sector Momentum Index

(76) Inventors: Antoine Segaud, New York, NY (US); Bertrand Jean Delarue, Paris (FR)

Correspondence Address: MORGAN LEWIS & BOCKIUS LLP, 1111 PENNSYLVANIA AVENUE NW, WASHINGTON, DC, 20004, US

(21) Appl. No.: 12/021,023

(22) Filed: Jan. 28, 2008

Related U.S. Application Data
(60) Provisional application No. 60/897,752, filed on Jan. 26, 2007.

(51) Int. Cl. G06Q 40/00

(52) U.S. Cl. 705/36 R

(57) ABSTRACT

A securities index is provided by identifying a first index that has a plurality of sub-components; constructing a portfolio that has a plurality of sub-portfolios, each sub-portfolio containing holdings corresponding to one of the index sub-components, and each sub-portfolio having a corresponding initial weight with respect to the portfolio. A second index is defined that corresponds to performance of the portfolio. Performance for each of said sub-components relative to performance of said first index is calculated. A correlation of each of said sub-components with said first index is calculated. The portfolio is periodically rebalanced by increasing weights of sub-portfolios corresponding to sub-components that out-perform the first index and decreasing weights of sub-portfolios corresponding to sub-components under-performing the first index; except that for sub-components having the respective calculated correlation differing with the first index, corresponding sub-portfolios do not have weight increased.

### CROSS-REFERENCE TO RELATED APPLICATIONS

This application claims the benefit of U.S. Provisional Patent Application No. 60/897,752, filed Jan. 26, 2007. The entire contents of that application are incorporated herein by reference.

### INTRODUCTION

An embodiment of the present invention (referred to herein for convenience as the SPECTRUM US Index”) is an index that preferably is positioned as a “US equity large cap” investment, and which aims to outperform the S&P 500 Total Return Index (“SPTR”).

Preferably, in this embodiment, the SPECTRUM US Index takes an innovative sectorial allocation approach by applying the methodology of “momentum investing” to the ten component sub-Indices of the S&P 500 index. According to this methodology, the SPECTRUM US Index is rebalanced daily to account for the different performances of the sub-indices relative to the SPTR. On each day, two steps are performed to compute new sub-index weights.

In the first step, sub-indices that perform well relative to the SPTR (on the basis of the semi-annual performance of a semi-annual moving average) have their relative weight in the SPECTRUM US Index increased, while sub-indices that perform poorly have their relative weight reduced.

In the second step, a “benchmarking” methodology is applied to make SPECTRUM US an efficient tracker of the SPTR: the weights are modified according to correlations between each sub-index and the SPTR. Poorly correlated sub-indices may see their weight reduced, while highly correlated indices may see their weight increased. In other words, over or under weighting of each sub-index will be approximately proportional to a 6 month correlation of its daily returns with SPTR's daily returns. Once the new weights are computed, they are compared to the current weights. If the new weights are sufficiently different from the current weights, e.g., that they exceed a threshold difference, the SPECTRUM US Index is rebalanced: the current weights are reset to the new computed weights. Otherwise, the current weights are left unchanged.

The criteria for changing weights preferably are determined by mathematical formulae described herein.

### OVERVIEW OF CERTAIN EMBODIMENTS

1. SPECTRUM US Index

The SPECTRUM US Index is an index that tracks the value of a portfolio. An embodiment is based upon a portfolio composed of the ten S&P 500 Sub-Indices (“the Sub-Indices”) representing the ten Level 1 GICS Sectors (see TABLE 1 below):

TABLE 1

S&P 500 Consumer Discretionary
Index
S&P 500 Consumer Staples Index
S&P 500 Energy Index
S&P 500 Financials Index
S&P 500 Health Care Index
S&P 500 Industrials Index
S&P 500 Materials Index
S&P 500 Telecommunication Index
S&P 500 Information Technology
Index
S&P 500 Utilities Index

A Calculation Agent calculates and rebalances daily the SPECTRUM US Index based on the allocation methodology described below.

2. Sectors Assigned to the SPECTRUM US Index
S&P uses the Global Industry Classification Standard (“GICS”), an industry model recognized by market participants worldwide, as the structure for all S&P indices. Investors use S&P sector indices across all areas of the equity markets—including asset management, sector research, portfolio strategy, peer analysis, and client account reporting. The use of GICS enables market participants to identify and analyze a customized group of companies from a common global standard. More detailed information published by S&P on understanding the sectors underlying the sub-indices and the GICS standard is available at S&P's website (standardandpoors.com).

3. Construction of the SPECTRUM US Index

The SPECTRUM US Index preferably is constructed using a hardwired formula-based selection and rebalancing methodology that assigns specific weights to each of the underlying Sub-Indices and recalculates such weights on a daily basis.

Sub-Indices Values

The SPECTRUM US Index preferably is a Total Return Index, which means that the distributions paid by any of the Sub-Indices are continuously re-invested in the SPECTRUM US Index. A preferred process of dividend reinvestment is detailed below in the section entitled “Sectors Total Return Level Calculation.”

Index Calculation

In an embodiment, the SPECTRUM US Index is calculated by reference to Sectors Total Return Levels and Sector Weights, which preferably are derived from the Allocation Methodology (see below). The SPECTRUM US Index calculation is explained below in the section entitled “Index Calculation Methodology.” The Index is rebalanced on each Reallocation Date, with new weights being assigned to each of the Sub-Indices, when a Reallocation Event is deemed to occur as determined by a Calculation Agent (see the section below entitled “Sector Weight Determination”).

Allocation Methodology

Exemplary Allocation Methodology is described in detail below. A brief overview is included here:

A. How the Weights of each Sub-Index are Calculated

On any Index Calculation Day, Target Weights will be calculated for each of the Sub-Indices. These Target Weights are factoring in trend indicators so that out-performing sectors have a greater Target Weight than under-performing ones. On each Reallocation Date, the SPECTRUM US Index will be rebalanced, with the weight of each Sub-Index being set equal to its Target Weight on the day the Reallocation Event occurred.

B. When SPECTRUM US Index is Rebalanced

The Target Weights, calculated on each Index Calculation Day, factor in the latest trend indicators available. The SPECTRUM US Index allocation must be close enough to this target allocation, so that a Reallocation Event is deemed to occur when the set of Weights used in the SPECTRUM US Index is different enough from the set of Target Weights. To quantify this difference, the Distance is calculated on each Index Calculation Day.

Additions/Deletions of Sub-Indices

The composition of the Sub-Indices that underlie the SPECTRUM US Index will be constant, provided that, if S&P adds or deletes a certain Sub-Index from its portfolio of indices, the SPECTRUM US Index shall be modified accordingly. However, the Allocation Methodology preferably shall remain the same.

Index Level: The SPECTRUM US Index Level will be determined by the Calculation Agent by reference to the value of a Portfolio giving exposure to a basket of 10 S&P 500 Sub-Indices as described herein. The SPECTRUM US Index Level is a function of 10 Sector Total Return Levels, which are calculated below in the section entitled “Sector Total Return Level Calculation.”

TABLE 2

| Sector | S&P 500 Sub-Indices |
|---|---|
| Consumer Discretionary | S&P 500 Consumer Discretionary Index |
| Consumer Staples | S&P 500 Consumer Staples Index |
| Energy | S&P 500 Energy Index |
| Financial | S&P 500 Financials Index |
| Healthcare | S&P 500 Health Care Index |
| Industrial | S&P 500 Industrials Index |
| Materials | S&P 500 Materials Index |
| Telecommunication | S&P 500 Telecommunication Index |
| Technology | S&P 500 Information Technology Index |
| Utilities | S&P 500 Utilities Index |

Allocation Methodology: The SPECTRUM US Index Allocation may be modified from the Initial Calculation Date in accordance with the Allocation Methodology described below.

Exemplary Terms:

Calculation Agent: Standard & Poor's

Initial Index Calculation Day: 2^{nd} Jan. 1991

Index Calculation Day: New York, Sector Calculation Day

Initial Sectors Calculation Day: 2^{nd} Jan. 1990

Sector Calculation Day: New York and any day on which a Close Value is published for the 10 above listed S&P 500 Sub-Indices.

An embodiment of the invention is directed to a method for providing a securities index, that comprises identifying a first index having a plurality of sub-components; constructing a portfolio having a plurality of sub-portfolios, each sub-portfolio containing holdings corresponding to one of said sub-components, and each sub-portfolio having a corresponding initial weight with respect to said portfolio; defining a second index corresponding to performance of said portfolio; calculating performance for each of said sub-components relative to performance of said first index; calculating a correlation of each of said sub-components with said first index; and periodically rebalancing said portfolio by increasing weights of sub-portfolios corresponding to sub-components out-performing said first index and decreasing weights of sub-portfolios corresponding to sub-components under-performing said first index; except that for sub-components having the respective calculated correlation differing with said first index, corresponding sub-portfolios do not have weight increased. Some embodiments of the invention also include: providing one or more exchange traded notes based on said second index, exchange traded notes do not pay interest during the term of said notes, said first index is a total return index, said second index is a total return index, said portfolio is rebalanced daily, said first index is the S&P 500 Total Return Index, and/or each of said sub-components receives a weight increase or decrease only when said weight increase or decrease when compared to a prior weight for each of said sub-components exceeds a specified threshold value.

Another embodiment of the invention is directed to software stored on a computer readable medium comprising: software for identifying a first index having a plurality of sub-components; software for constructing a portfolio having a plurality of sub-portfolios, each sub-portfolio containing holdings corresponding to one of said sub-components, and each sub-portfolio having a corresponding initial weight with respect to said portfolio; software for defining a second index corresponding to performance of said portfolio; software for calculating performance for each of said sub-components relative to performance of said first index; software for calculating a correlation of each of said sub-components with said first index; and software for periodically rebalancing said portfolio by increasing weights of sub-portfolios corresponding to sub-components out-performing said first index and decreasing weights of sub-portfolios corresponding to sub-components under-performing said first index; except that for sub-components having the respective calculated correlation differing with said first index, corresponding sub-portfolios do not have weight increased. Other embodiments of the invention include: providing one or more exchange traded notes based on said second index, said exchange traded notes do not pay interest during the term of said notes, said first index is a total return index, said second index is a total return index, said portfolio is rebalanced daily, said first index is the S&P 500 Total Return Index, and/or each of said sub-components receives a weight increase or decrease only when said weight increase or decrease when compared to a prior weight for each of said sub-components exceeds a specified threshold value.

### BRIEF DESCRIPTION OF THE DRAWINGS

FIG. 1 depicts a computer system for implementing an embodiment of the invention.

FIG. 2 depicts a flowchart of a method according to an embodiment of the invention.

### DETAILED DESCRIPTION

I. Sectors Total Return Level Calculation

Summary: The purpose of this section is to describe, for an exemplary embodiment, the Sector Total Return Levels that will be representative of each Level 1 GICS Sector. Each Sector is associated with an S&P 500 Sub-Index. On each Sector Calculation Day, the Sector Total Return Levels are calculated by reinvesting the dividends paid by the relevant S&P 500 Sub-Index on this Index Calculation Day (1).

Sector Description: Each Level 1 GICS sector is represented by an S&P 500 Sub-Index:

TABLE 3

| | | | S&P 500 Sub- |
|---|---|---|---|
| | | | Index i |
| | | | Bloomberg |
| I | Sector i | S&P 500 Sub-Index i | Ticker |
| 1 | Consumer | S&P 500 Consumer | S5COND Index |
| | Discretionary | Discretionary Index | |
| 2 | Consumer Staples | S&P 500 Consumer Staples | S5CONS Index |
| | | Index | |
| 3 | Energy | S&P 500 Energy Index | S5ENRS Index |
| 4 | Financial | S&P 500 Financials Index | S5FINL Index |
| 5 | Healthcare | S&P 500 Health Care Index | S5HLTH Index |
| 6 | Industrial | S&P 500 Industrials Index | S5INDU Index |
| 7 | Materials | S&P 500 Materials Index | S5MATR Index |
| 8 | Telecommunication | S&P 500 | S5TELS Index |
| | | Telecommunication Index | |
| 9 | Technology | S&P 500 Information | S5INFT Index |
| | | Technology Index | |
| 10 | Utilities | S&P 500 Utilities Index | S5UTIL Index |

Sector Level On the Initial Sectors Calculation Day, the Initial Sector i Total Return Level will be determined as follows, for i=1 . . . 10:

Sector₀ⁱ=100

On each Index Calculation Day, the Sector i Total Return Level will be determined as follows, for i=1 . . . 10:

$${Sector}_{t}^{i} = {Sector}_{t - 1}^{i} \cdot \frac{{SubIndex}_{t}^{i} + {SubIndexDiv}_{t}^{i}}{{SubIndex}_{t - 1}^{i}} \qquad ( 1 )$$

Where:

Sectorⁱₜ₋₁ is the Sector i Total Return Level as of the Sectors Calculation Day preceding t.

SubIndexⁱₜ is the S&P 500 Sub-Index i Close Level as of Sectors Calculation Day t, as published on the above relevant Bloomberg Page.

SubIndexⁱₜ₋₁ is the S&P 500 Sub-Index i Close Level as of the Sectors Calculation Day preceding t, as published on the above relevant Bloomberg Page.

SubIndexDivⁱₜ is the S&P 500 Sub-Index i Net Dividend detached on Sectors Calculation Day t.

II. Index Calculation Methodology

Summary: The purpose of this section is to describe, for an exemplary embodiment, SPECTRUM US Index Level in reference to the various Sector Total Returns, as described in the preceding section, and the various Sector Weights, as described in the following section. As detailed in the section entitled “Allocation Methodology,” the SPECTRUM US Index preferably is rebalanced only on Reallocation Dates. Consequently, on each Index Calculation Date, the SPECTRUM US Index level will be calculated in reference to the SPECTRUM US Index Level as of the strictly preceding Reallocation Date, and the Sector Weights as determined on this Reallocation Date. The Performance of the SPECTRUM US Index since the strictly preceding Reallocation Date is equal to the sum of the Sector Total Return Level performances since the last Reallocation Date weighted by the Sector Weights determined on this Reallocation Date (see (2) below).

Index Level: On the Initial Index Calculation Day, the Initial Index Level will be determined as follows:

Index₀=100

On each Index Calculation Day t, SPECTRUM US Index Level will be determined as follows:

$${Index}_{t} = {Index}_{r} \cdot {\sum }_{i = 1}^{10} ( {W}_{r}^{i} \cdot \frac{{Sector}_{t}^{1}}{{Sector}_{r}^{i}} ) \qquad ( 2 )$$

Where:

Indexᵣ is Index Level as of the Reallocation Date strictly preceding SPECTRUM US Index Calculation Day t.

The Initial Index Calculation Day is a Reallocation Date.

Wᵣⁱ is Sector i Weight in SPECTRUM US Index as of the Reallocation Date strictly preceding SPECTRUM US Index Calculation Day t, as defined in the next section (“Allocation Methodology”).

Sectorₜⁱ is Sector i Total Return Level as of Index Calculation Day t, as defined in the preceding section (“Sectors Total Return Level Calculation”).

Sectorᵣⁱ is Sector i Total Return Level as of the Reallocation Date strictly preceding SPECTRUM US Index Calculation Day t.

III. Allocation Methodology

Summary: The purpose of this section is to describe, for an exemplary embodiment, SPECTRUM US Index Allocation between the 10 Sectors used in an embodiment.

How the Weights of the Sub-Indices are Calculated

On any Index Calculation Day, Target Weights will be calculated for each of the Sub-Indices. This is the purpose of the Section Target Weight Determination. On any Index Calculation Day, each Sector is given a Target Weight, in accordance with the following procedure:

This methodology is based on trend following. Using the sliding average of the close levels for each Sub-index and SPTR permits determination and comparison of the trends between these sectors and the S&P 500 Total Return. The Average Level is defined as the average of the Close Levels over the last 120 Sector Calculation Days. See (6) & (8) below.

Then the trend of each sector and SPTR will be quantified by calculating the Sector and SPTR Performances. These Performances will represent the trend in the rest of this methodology. They are calculated as the Annualized Performances over the last 120 Sector Calculation Days of the Average Levels. See (5) & (7) below.

These Performances, representing trends, will then be used in the calculation of the Sector Coefficients (4). The goals of this formula are:

(a) To give a greater Coefficient to Sectors showing a greater Performance than the S&P 500 Total Return's Performance, and conversely (i.e., a smaller coefficient is given to Sectors showing a lesser Performance). Sectors out-performing SPTR will be given a Sector Coefficient greater than 1, out-performance being defined as a Performance greater than SPTR's Performance. Sector under-performing SPTR will be given a Sector Coefficient lower than 1, so that out-performing Sectors, in the sense of the indicators used in the methodology, will be over-weighted in SPECTRUM US Index, and conversely (under-performing Sectors are under-weighted).

(b) To control and to limit the over-weighting of Sectors showing a poor correlation with the S&P 500 Total Return. Indeed, an excessive over-weighting of Sectors poorly correlated to SPTR would result in SPECTRUM US Index itself showing a poor correlation with the S&P 500 Total Return. As an example, Sectors anti-correlated with SPTR (i.e., showing a correlation with SPTR negative or equal to zero) will be given a Sector Coefficient of 1. Over or under weighting of each sub-index may be approximately proportional to a 6 month correlation of its daily returns with SPTR's daily returns so that sub-indices well correlated with SPTR will be over-weighted. The Sector Coefficients are not Weights. Indeed, their sum is likely to be different than 1. The Sector Target Weights are calculated by normalizing the Sector Coefficients (see (3) below), which means that the Sector Target Weights are proportional to the Sector Coefficients and that their sum is equal to 1.

When the SPECTRUM US Index is Rebalanced

The Target Weights are calculated on a daily basis. They factor in the latest information for implementing a momentum strategy, given the trend indicators that are used. However, SPECTRUM US Index preferably is not rebalanced every day. It is rebalanced only when the Target Allocation is deemed different enough from the Allocation which was used in the SPECTRUM US Index since the latest Reallocation Date. In order to quantify this difference and determine the occurrence of a Reallocation Event, the following procedure is applied on a daily basis:

(i) The Target Allocation and the Allocation can be represented by two vectors, made of the 10 Sector Target Weights, for the Target Allocation, and the 10 Sector weights for the Allocation in place in SPECTRUM US Index. The Distance, as calculated in (10) is a positive number that quantifies how different these two vectors are, and therefore quantifies the difference between Target and Sector Weights.

For example, if, for any given Sector, the Sector Target Weight is equal to the Sector Weight, the Distance will be equal to zero. For any particular Sector, the greater the difference between the Target Sector Weight and the Sector Weight, the greater the Distance.

(ii) A Reallocation Event is deemed to occur if the Distance is strictly greater than 20%.

(iii) Then, SPECTRUM US Index Rebalancing will take place two Index Calculation Days after the occurrence of a Reallocation Event (see (9) below).

IV. Sector Target Weights Determination

Target Weights: On each Index Calculation Day, the Sector i Target Weight will be determined as follows, for i=1 . . . 10:

$${Wtg}_{t}^{i} = \frac{{Coeff}_{t}^{i}}{{\sum }_{i = i}^{10} {Coeff}_{t}^{i}} \qquad ( 3 )$$

Where: Coeffₜⁱ is Sector i Target Coefficient as of Index Calculation Day t.

Target Coefficients: On each Index Calculation Day, the Sector i Target Coefficient will be determined as follows, for i=1 . . . 10:

$${Coeff}_{t}^{i} = Max [ 0 , 1 + Max ( {ρ}_{t}^{i} , 0 \% ) \times 150 \% \times \frac{{Perf}_{t}^{i} - {Perf}_{t}^{SPTR}}{\frac{1}{10} {\sum }_{j = 1}^{10} \vert {Perf}_{t}^{i} - {Perf}_{t}^{SPTR} \vert} ] \qquad ( 4 )$$

Where:

ρₜⁱ is Sector i Correlation as of Index Calculation Day t;

Perfₜⁱ is Sector i Performance as of Index Calculation Day t; and

Perfₜ^{SPTR} is SPTR Performance as of Index Calculation Day t.

Sector Correlation: The Sector i Correlation as of Index Calculation Day t, ρₜⁱ, will be determined by the Calculation Agent, for i=1 . . . 10, as the Correlation of the Daily Returns of Sector i with the Daily Returns of SPTR, over a period of 120 Index Calculation Days ending on Index Calculation Day t.

Sector Performance: On each Index Calculation Day, the Sector i Performance will be determined as follows, for i=1 . . . 10:

$${Perf}_{t}^{i} = {( \frac{{Average}_{t}^{i}}{{Average}_{t - 120}^{i}} )}^{2} - 1 \qquad ( 5 )$$

Where:

Averageₜⁱ is Sector i Average Level as of Index Calculation Day t; and

Averageⁱₜ₋₁₂₀ is Sector i Average Level as of the Sector Calculation Day which 120 Sector Calculation Days before Index Calculation Day t.

Sector Average Level: On each Sectors Calculation Day, the Sector i Average Level will be determined as follows, for i=1 . . . 10:

$${Average}_{t}^{i} = \frac{1}{120} {\sum }_{s = 0}^{119} {Sector}_{t - s}^{i} \qquad ( 6 )$$

Where:

Sectorⁱₜ₋ₛ is Sector i Total Return Level as of the Sector Calculation Day which is s Sector Calculation Days before Sector Calculation Day t.

SPTR Performance: On each Index Calculation Day, the SPTR Performance will be determined as follows:

$${Perf}_{t}^{SPTR} = {( \frac{{Average}_{t}^{SPTR}}{{Average}_{t - 120}^{SPTR}} )}^{2} - 1 \qquad ( 7 )$$

Where:

Averageₜ^{SPTR} is SPTR Average Level as of Index Calculation Day t; and

Average^{SPTR}ₜ₋₁₂₀ is SPTR Average Level as of the Sector Calculation Day which 120 Sector Calculation Days before Sector Calculation Day t.

SPTR Average Level: On each Index Calculation Day, the SPTR Average Level will be determined as follows:

$${Average}_{t}^{SPTR} = \frac{1}{120} {\sum }_{s = 0}^{119} {SPTR}_{t - s} \qquad ( 8 )$$

Where: SPTRₜ₋ₛ is SPTR Close Level as of the Sector Calculation Day which is s Sector Calculation Days before Sector Calculation Day t.

V. Sector Weights Determination

Sector Weights On the Initial Index Calculation Day, the Initial Sector i Weights will be determined as follows, for i=1 . . . 10:

W₀ⁱ=Wtg₀ⁱ

Where:

Wtgⁱ₀ is Sector i Target Weight as of the Initial Index Calculation Date.

The Initial Index Calculation Day preferably is a Reallocation Date.

On each Index Calculation Day t, following the determination of the Sector Target Weights, the Calculation Agent will determine SPECTRUM US Index Allocation between the Sectors as follows:

If t+1 is a Reallocation Date, then t+2 won't be a Reallocation Date.

If t+1 is not a Reallocation Date, and Distanceₜ≦20%, then t+2 won't be a Reallocation Date.

If t+1 is not a Reallocation Date, and Distanceₜ>20%, then a Reallocation Event is deemed to occur and t+2 will be a Reallocation Date: for i=1 . . . 10, Wₜ₊₂ⁱ=Wtgₜⁱ (9)

Where:

t+1 is Index Calculation Day which is I Index Calculation Day after Index Calculation Day t.

t+2 is Index Calculation Day which is 2 Index Calculation Days after Index Calculation Day t.

Distanceₜ is the Distance as of Index Calculation Day t.

Distance: On each Index Calculation Day t, the Distance will be calculated as follows:

$${Distance}_{t} = \sqrt{{\sum }_{t = 1}^{10} {( {W}_{r}^{i} - {Wtg}_{t}^{i} )}^{2}} \qquad ( 10 )$$

Where:

Wₜⁱ is Sector i Weight as of the Reallocation Date strictly preceding SPECTRUM US Index Calculation Day t; and

Wtgₜⁱ is Sector i Target Weight as of Index Calculation Day t.

Exemplary Terms for Exchange Traded Notes

Exemplary terms for Exchange Traded Notes linked to the SPECTRUM US Sector Momentum Index are provided below.

The Exchange-Traded Notes due [], 2016 (the “Securities”) are linked to the SPECTRUM US Sector Momentum Index, do not guarantee any return of principal at maturity, and do not pay any interest during their term. Instead, a purchaser will receive a cash payment at maturity or early redemption based on the performance of the S&P Custom/BNP Paribas—SPECTRUM US Sector Momentum Index less an investor fee. The principal terms of the Securities are as follows:

Issuer: [Issuer]

Underlying Index The return on the Securities is linked to the performance of the SPECTRUM US Sector Momentum Index (the “Index”). The Index is positioned as a “U.S. equity large cap” investment. The Index is published under the symbol <Index>.

Payment at Maturity: If a purchaser holds his or her Securities to maturity, the purchaser will receive a cash payment at maturity equal to the principal amount of the held Securities limes the index factor on the final valuation date limes the fee factor on the final valuation date.

Secondary Market: The Securities are listed on the New York Stock Exchange under the ticker symbol “[Securities Symbol]”. If an active secondary market in the Securities develops, we expect that investors will purchase and sell the Securities primarily in this secondary market.

Early Redemption: Subject to the notification and minimum amount requirements described below, a purchaser may redeem his Securities on any redemption date during the term of the Securities. If the purchaser redeems his Securities, he will receive a cash payment in an amount equal to the weekly redemption value, which is the principal amount of his Securities times the index factor on the applicable valuation date limes the fee factor on the applicable valuation date. The purchaser must redeem at least 250,000 Securities (a principal amount equal 1-NY/2266897.2 to at least $2.5 million) at one time in order to exercise his right to redeem his Securities on any redemption date.

Redemption Mechanics: In order to redeem his Securities on a redemption date, a purchaser must deliver a notice of redemption via email by no later than 11:00 a.m. New York City time on the business day prior to the applicable valuation date.

Valuation Date: Valuation date means each [Thursday] from [], 2007 to [], 2017 inclusive or, if such date is not a trading day, the next succeeding trading day, not to exceed five business days. We refer to [Thursday], [], 2017, as the “final valuation date.”

Redemption Date: A redemption date is the third business day following a valuation date (other than the final valuation date). The final redemption date will be the third business day following the valuation date that is immediately prior to the final valuation date.

Inception Date: [], 2007.

Index Factor: The index factor on any given day will be equal to the closing value of the Index on that day divided by the initial index level. The initial index level is the closing value of the Index on the inception date.

Fee Factor: The fee factor is equal to one minus the investor fee. The investor fee is equal to 0.75% times the number of calendar days elapsed from the inception date up to and including the applicable valuation date divided by 365.

Because the investor fee and the fee factor reduce the amount of return at maturity or upon redemption, the value of the Index must increase significantly in order for a purchaser to receive at least the principal amount of your investment at maturity or upon redemption. If the value of the Index decreases or does not increase sufficiently, a purchaser will receive less than the principal amount of his investment at maturity or upon redemption.

Trading Day: A trading day is a day on which (i) the value of the Index is calculated and published, (ii) trading is generally conducted on the New York Stock Exchange, and (iii) trading is generally conducted on the markets on which the futures contracts underlying the Index are traded, in each case as determined by the calculation agent in its sole discretion.

Valuation of the Securities

The market value of the Securities will be affected by several factors. We expect that generally the value of the Index on any day will affect the market value of the Securities more than any other factors. Other factors that may influence the market value of the Securities include, but are not limited to, supply and demand for the Securities, the volatility of the Index, the levels of the Sub-indices, the market price of the Index Components, prevailing interest rates, the volatility of securities markets, economic, financial, political, regulatory, geographical, biological or judicial events that affect the value of the Index or the market price of Index Components, the general interest rate environment, as well as the perceived creditworthiness of AIG.

### Indicative Value

An intraday “indicative value” meant to approximate the intrinsic economic value of the Securities will be calculated:

Indicative Value=Principal Amount per Security×(Current Index Level/Initial Index Level)×Current Fee Factor

where: Principal Amount per Security=$10; Current Index Level=The most recent published level of the Index as reported by the AIG-FP; Initial Index Level=The level of Index on the inception date; and Current Fee Factor=The most recent daily calculation of the fee factor with respect to your Securities, determined as described above (which, during any trading day, will be the fee factor determined on the preceding calendar day).

The indicative value will be derived from sources deemed reliable.

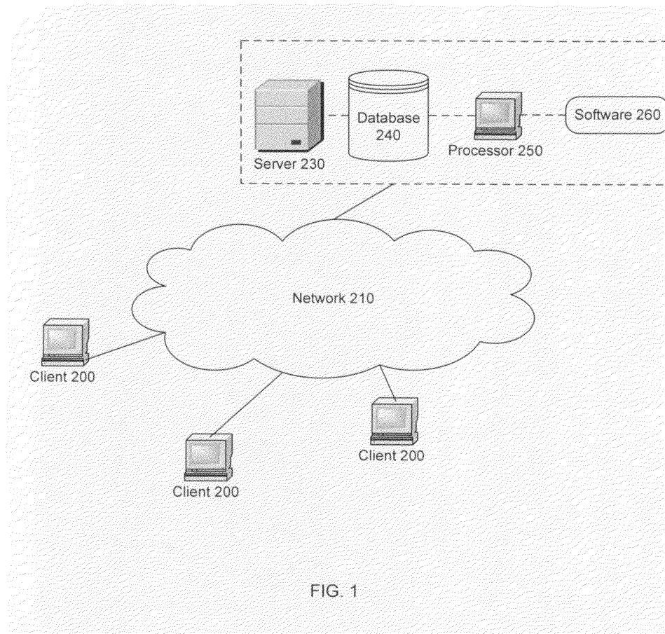

Inventions described herein may be automated and used in the exemplary system of FIG. 1. As shown, client computers 200 communicate via network 210 with a central server 230 which is coupled to one or more databases 240, one or more processors 250, and software 260. Other components and combinations of components may also be used to support processing and calculations described herein as will be evident to one of skill in the art. Server 230 facilitates communication of returns data from a database 240 to and from clients 200. Processor 250 provides calculations relevant to calculations described herein. Software 260 can be installed locally at a client 200 and/or centrally supported for facilitating calculations and applications. For example, software 260 may be used in embodiments where a threshold, e.g., for weights is established.

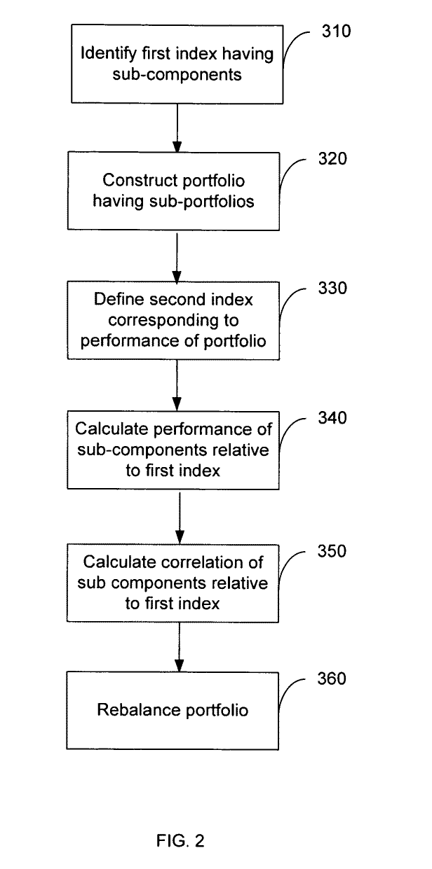

Embodiments of the invention may be provided according to the flowchart of FIG. 2. As shown, a first index having sub components is identified, step 310. A portfolio is constructed having sub-portfolios, step 320. A second index is defined corresponding to performance of the portfolio, step 330. A performance of each of the sub-components relative to performance of the first index is calculated, step 340. A correlation of each of the sub components relative to the first index is calculated, step 350. The portfolio is rebalanced, step 360.

Although certain embodiments have been described in detail herein, it will be apparent to those skilled in the relevant art that various modifications, additions, substitutions and the like can be made without departing from the scope of the invention as defined in the following claims.

We claim:

1. A method for providing a securities index, comprising:
identifying a first index having a plurality of sub-components;
constructing a portfolio having a plurality of sub-portfolios, each sub-portfolio containing holdings corresponding to one of said sub-components, and each sub-portfolio having a corresponding initial weight with respect to said portfolio;
defining a second index corresponding to performance of said portfolio;
calculating performance for each of said sub-components relative to performance of said first index;
calculating a correlation of each of said sub-components with said first index; and
periodically rebalancing said portfolio by increasing weights of sub-portfolios corresponding to sub-components out-performing said first index and decreasing weights of sub-portfolios corresponding to sub-components under-performing said first index;
except that for sub-components having the respective calculated correlation differing with said first index, corresponding sub-portfolios do not have weight increased.

2. A method as in claim 1, further comprising providing one or more exchange traded notes based on said second index.

3. A method as in claim 2, wherein said exchange traded notes do not pay interest during the term of said notes.

4. A method as in claim 1, wherein said first index is a total return index.

5. A method as in claim 1, wherein said second index is a total return index.

6. A method as in claim 1, wherein said portfolio is rebalanced daily.

7. A method as in claim 1. wherein said first index is the S&P 500 Total Return Index.

8. A method as in claim 1, wherein each of said sub-components receives a weight increase or decrease only when said weight increase or decrease when compared to a prior weight for each of said sub-components exceeds a specified threshold value.

9. Software stored on a computer readable medium comprising:
software for identifying a first index having a plurality of sub-components;
software for constructing a portfolio having a plurality of sub-portfolios, each sub-portfolio containing holdings corresponding to one of said sub-components, and each sub-portfolio having a corresponding initial weight with respect to said portfolio;
software for defining a second index corresponding to performance of said portfolio;
software for calculating performance for each of said sub-components relative to performance of said first index;
software for calculating a correlation of each of said sub-components with said first index; and
software for periodically rebalancing said portfolio by increasing weights of sub-portfolios corresponding to sub-components out-performing said first index and decreasing weights of sub-portfolios corresponding to sub-components under-performing said first index;
except that for sub-components having the respective calculated correlation differing with said first index, corresponding sub-portfolios do not have weight increased.

10. Software as in claim 9, further comprising providing one or more exchange traded notes based on said second index.

11. Software as in claim 10 wherein said exchange traded notes do not pay interest during the term of said notes.

12. Software as in claim 9, wherein said first index is a total return index.

13. Software as in claim 9, wherein said second index is a total return index.

14. Software as in claim 9, wherein said portfolio is rebalanced daily.

15. Software as in claim 9, wherein said first index is the S&P 500 Total Return Index.

16. Software as in claim 9, wherein each of said sub-components receives a weight increase or decrease only when said weight increase or decrease when compared to a prior weight for each of said sub-components exceeds a specified threshold value.
